(19) United States
(12) Patent Application Publication
(10) Pub. No.: US 2017/0187017 A1
(43) Pub. Date: Jun. 29, 2017

(54) BATTERY ACCOMMODATING DEVICE AND BATTERY MODULE HAVING THE SAME

(71) Applicant: BYD COMPANY LIMITED, SHENZHEN (CN)

(72) Inventors: XUEFENG ZHANG, SHENZHEN (CN); YAN ZHU, SHENZHEN (CN); QINGBO PENG, SHENZHEN (CN); JIA LU, SHENZHEN (CN); WEI LIU, SHENZHEN (CN)

(21) Appl. No.: 15/458,295

(22) Filed: Mar. 14, 2017

Related U.S. Application Data
(63) Continuation of application No. PCT/CN2015/081870, filed on Jun. 18, 2015.

(30) Foreign Application Priority Data
Sep. 30, 2014 (CN) 201410522215.X
Sep. 30, 2014 (CN) 201420569533.7

(51) Int. Cl. H01M 2/10

(52) U.S. Cl. CPC H01M 2/1077

(57) ABSTRACT

A battery accommodating device and a battery module including the same are provided. The battery accommodating device includes: an outer insertion-connected assembly comprising outer components; an inner insertion-connected assembly comprising inner components and disposed between the outer components; and a chamber configured to accommodate a battery and defined between the inner components and outer components. Each of the outer components is fitted with an inner component via a sliding rail structure.

### CROSS-REFERENCE TO RELATED APPLICATION

This application is a continuation application of International Application No. PCT/CN2015/081870, filed on Jun. 18, 2015, which is based on and claims priority to and benefits of Chinese Patent Application No. 201410522215.X and No. 201420569533.7, both filed with the State Intellectual Property Office (SIPO) of the People's Republic of China on Sep. 30, 2014. The entire content of the above-referenced applications are incorporated herein by reference.

### FIELD

Embodiments of the disclosure generally relate to batteries, and more particularly to a battery accommodating device and a battery module having the same.

### BACKGROUND

In the related art, a power battery module usually uses a battery accommodating device with a multi-plate assembling structure or an upper-lower shell assembling structure. Although the battery accommodating device with the aforementioned structures can provide a good protection for batteries, a combination of the batteries cannot be freely extended due to limitations of the multi-plate assembling structure and the upper-lower shell assembling structure. In detail, the aforementioned structure of the battery accommodating device is required to be redesigned if the combination of the batteries is changed, thus greatly increasing time and cost of R&D project. Meanwhile, the aforementioned structures of the battery accommodating device are not conducive to an automatic production of a power battery module, which potentially increase a production cost of the power battery module, thus losing the competitive advantages of the product.

### SUMMARY

In viewing thereof, the present disclosure is directed to solve at least one problem existing in the art. For this reason, the present disclosure provides a battery accommodating device, which is easy to extend and assemble.

The present disclosure also provides a battery module which may have a high expansibility, low R&D cost and short time for development.

Embodiments of a first aspect of the present disclosure provide a battery accommodating device that includes a battery housing. The battery housing includes an outer insertion-connected assembly including first and second outer insertion-connected components opposite to and spaced from each other in a right and left direction. The battery housing also includes an inner insertion-connected assembly disposed between the first and second outer insertion-connected components in the right and left direction, and including first and second inner insertion-connected components staggered with each other in a front and rear direction. The battery housing further includes a chamber configured to accommodate a battery. and the chamber is defined between the inner insertion-connected components of the inner insertion-connected assembly, and between the inner insertion-connected component and adjacent one of the first and second outer insertion-connected components. Each of the first and second outer insertion-connected components is fitted with the first and second inner insertion-connected components via a sliding rail structure.

In some embodiments, a plurality of inner insertion-connected assemblies are disposed between the first and second outer insertion-connected components. The chamber is further defined between adjacent inner insertion-connected assemblies. Adjacent inner insertion-connected components are fitted with each other via the sliding rail structure.

In some embodiments, each of the first and second outer insertion-connected components has a sliding groove or a sliding block. Each of the first and second inner insertion-connected components has a sliding groove in a left side thereof and a sliding block on a right side thereof. The sliding groove of the inner insertion-connected component is adapted to fit with the sliding block of the outer insertion-connected component or the sliding block of an adjacent inner insertion-connected component.

In some embodiments, the outer insertion-connected component includes: an outer side plate having a first plate segment and a second plate segment; and an insertion-connected frame disposed on the first plate segment of the outer side plate. The first inner insertion-connected component of the inner insertion-connected assembly adjacent to the outer insertion-connected component is connected with the second plate segment of the outer side plate and opposite to the insertion-connected frame. The second inner insertion-connected component of the inner insertion-connected assembly adjacent to the outer insertion-connected component is connected with a side of the insertion-connected frame away from the outer side plate.

In some embodiments, the insertion-connected frame includes: an outer top plate connected with a top of the outer side plate and perpendicular thereto, an outer end plate connected with an end of the first plate segment of the outer side plate away from the second plate segment and perpendicular thereto; and an outer bottom plate connected with a bottom of the outer side plate and perpendicular thereto, and opposite to the outer top plate.

In some embodiments, each of the outer top plate and the outer bottom plate has a sliding groove or a sliding block at a side thereof away from the outer side plate. The sliding groove or the sliding block is adapted to fit with the second inner insertion-connected component of the inner insertion-connected assembly adjacent to the outer insertion-connected component.

In some embodiments, each of the outer top plate and the outer bottom plate has the sliding groove at the side thereof away from the outer side plate. The sliding groove is adapted to fit with the second inner insertion-connected component of the inner insertion-connected assembly adjacent to the outer insertion-connected component. The sliding groove of the outer top plate opens in a first direction opposite to a second direction in which the sliding groove of the outer bottom plate opens.

In some embodiments, the second plate segment of the outer side plate has a sliding groove or a sliding block at a top and a bottom thereof respectively. The sliding groove or the sliding block is adapted to fit with the first inner insertion-connected component of the inner insertion-connected assembly adjacent to the outer insertion-connected component.

In some embodiments, the second plate segment of the outer side plate has the sliding block at the top and the bottom thereof respectively. The sliding block is adapted to fit with the first inner insertion-connected component of the inner insertion-connected assembly adjacent to the outer insertion-connected component. The sliding block at the top of the second plate segment has an extending direction opposite to that of the sliding block at the bottom of the second plate segment.

In some embodiments, the outer end plate defines a first extraction hole penetrated therethrough.

In some embodiments, the inner insertion-connected component includes an inner top plate having a sliding groove at a left side thereof and a sliding block at a right side thereof. The sliding groove and the sliding block are adapted to fit with the outer insertion-connected component or the inner insertion-connected component adjacent thereto respectively. The inner insertion-connected component also includes an inner end plate disposed at a front end or a rear end of the inner top plate and perpendicular thereto, and an inner bottom plate disposed at a lower end of the inner end plate and perpendicular thereto. The inner bottom plate has a sliding groove at a left side thereof and a sliding block at a right side thereof. The sliding groove and the sliding block are adapted to fit with the outer insertion-connected component or the inner insertion-connected component adjacent thereto. The inner insertion-connected component also includes an inner baffle plate disposed at the left side or the right side of the inner top plate and perpendicular thereto, and connected with the inner end plate and the inner bottom plate.

In some embodiments, an extending direction of the sliding block of the inner top plate is opposite to that of the sliding block of the inner bottom plate. The sliding groove of the inner top plate opens in a first direction opposite to a second direction in which the sliding groove of the inner bottom plate opens.

In some embodiments, the inner end plate defines a second extraction hole penetrated therethrough.

In some embodiments, the inner baffle plate defines a notch that opens in a direction away from the inner end plate.

In some embodiments, the battery accommodating device further includes a plurality of protective covers. The protective covers are disposed at an end of the inner insertion-connected component adjacent to the inner end plate thereof and/or an end of the outer insertion-connected component adjacent to the outer end plate thereof.

In some embodiments, the inner top plate of the inner insertion-connected component or the outer top plate of the outer insertion-connected component defines a slot. The protective cover has a snap component adapted to fit within the slot at an upper end thereof, and a flange adapted to fit with the outer end plate or the inner end plate at a lower end thereof.

In some embodiments, the protective cover disposed at the end of the outer insertion-connected component has a first package edge adapted to fit with an outermost side of the outer insertion-connected component.

In some embodiments, the battery accommodating device further includes a mounting assembly. The mounting assembly is configured to connect the outer insertion-connected component with the inner insertion-connected component adjacent thereto, or connect adjacent inner insertion-connected components with each other.

In some embodiments, the mounting assembly includes: a first mounting component configured to connect the outer insertion-connected component with the first inner insertion-connected component of the inner insertion-connected assembly adjacent to the outer insertion-connected component; and a second mounting component configured to connect four adjacent inner insertion-connected components together or adjacent three inner insertion-connected components and one outer insertion-connected component together.

In some embodiments, the first mounting component includes a first snap part. Each of the outer top plate of the outer insertion-connected component, the outer bottom plate of the outer insertion-connected component, the inner top plate and the inner bottom plate of the first inner insertion-connected component of the inner insertion-connected assembly adjacent to the outer insertion-connected component defines a first snap opening adapted to fit with the first snap part.

In some embodiments, the first mounting component has a second package edge adapted to fit with the outer side plate.

In some embodiments, the second mounting component includes a second snap part. Each of the inner top plate, the inner bottom plate, the outer top plate and the outer bottom plate has a second snap opening adapted to fit with the second snap part.

With the battery accommodating device according to embodiments of the present disclosure, by disposing the outer insertion-connected assembly including the first and second outer insertion-connected components, and the inner insertion-connected assemblies including the first and second inner insertion-connected components, the chamber for housing the battery is defined by adjacent inner insertion components and by the inner insertion-connected component and adjacent outer insertion-connected component. The outer insertion-connected component and the inner insertion-connected component are fitted with the adjacent inner insertion-connected component via the sliding rail structure and detachably connected therewith respectively. Thus the number of batteries can be extended easily with the battery accommodating device according to actual requirements.

Besides, since the outer insertion-connected component and the inner insertion-connected component are detachably connected with the adjacent inner insertion-connected component respectively, the assembling and disassembling of the battery accommodating device both are easy to carry out. Thus the assembling process is simplified and assembling efficiency thereof is improved.

Further, the expansibility of the power battery module is improved, the R&D cost of the power battery module is decreased, and the time for development of the power battery module is shortened.

Embodiments of a second aspect the present disclosure provide a battery module. The battery module includes: a battery accommodating device according to above embodiments of the present disclosure, and at least one battery accommodated in a chamber of the battery accommodating device.

Additional aspects and advantages of the embodiments of the present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of the disclosure will become apparent and more readily appreciated from the following descriptions taken in conjunction with the drawings, in which:

FIG. 1 is an exploded view of a battery module according to an embodiment of the present disclosure;

FIG. 2 is a partially exploded view of a battery accommodating device according to another embodiment of the present disclosure;

FIG. 3 is a partially perspective view of a battery accommodating device according to another embodiment of the present disclosure;

FIG. 4 is a perspective view of an outer insertion-connected component of a battery accommodating device according to an embodiment of the present disclosure;

FIG. 5 is a perspective view of an inner insertion-connected component of a battery accommodating device according to an embodiment of the present disclosure;

FIG. 6 is a perspective view of a protective cover disposed at an end of the outer insertion-connected component of a battery accommodating device according to an embodiment of the present disclosure;

FIG. 7 is a top view of two inner insertion-connected components of two adjacent inner insertion assemblies of a battery accommodating device according to an embodiment of the present disclosure;

FIG. 8 is a schematic view of the two inner insertion-connected components as shown in FIG. 7 connected with each other via a second mounting component;

FIG. 9 is a perspective view from an angle of a first mounting component of a battery accommodating device according to an embodiment of the present disclosure;

FIG. 10 is a perspective view from another angle of the first mounting component as shown in FIG. 9;

FIG. 11 is a perspective view from an angle of a second mounting component of a battery accommodating device according to an embodiment of the present disclosure; and

FIG. 12 is a perspective view from another angle of the second mounting component as shown in FIG. 11.

### DETAILED DESCRIPTION

Reference will be made in detail to embodiments of the present disclosure. The embodiments described herein with reference to the accompany drawings are explanatory and illustrative, in which the same or similar reference numerals throughout signify the same or similar components or components having the same or similar functions. The embodiments are used to generally understand the present disclosure, and shall not be construed to limit the present disclosure.

In the specification, unless specified or limited otherwise, it should be understood that, terms used to denote the position or positional relationship such as “upper”, “lower”, “front”, “rear”, “left”, “right”, “vertically”, “horizontally”, “top”, “bottom”, “inner”, “outer” as well as derivative thereof should be construed to refer to the position or positional relationship as then described or as shown in the drawings. These relative terms are for convenience of description and do not require that the present disclosure be constructed or operated in a particular position. In additive, terms such as “first” and “second” are used herein for purposes of description and are not intended to indicate or imply relative importance or significance. The features limited by “first” and “second” may indicate or imply that the number of the features is more than one. In the description of the present disclosure, unless specified or limited otherwise, “a plurality of” means two or more than two.

In the description of the present disclosure, unless specified or limited otherwise, it should be noted that, terms such as “fixed”, “mounted”, “connected” may be understood broadly, such as permanent connection, detachable connection, integrally connection, direct connection or indirect connection via intermediary, or inner communication or inter-reaction between two components. Those having ordinary skills in the art should understand the specific meanings in the present disclosure according to specific situations.

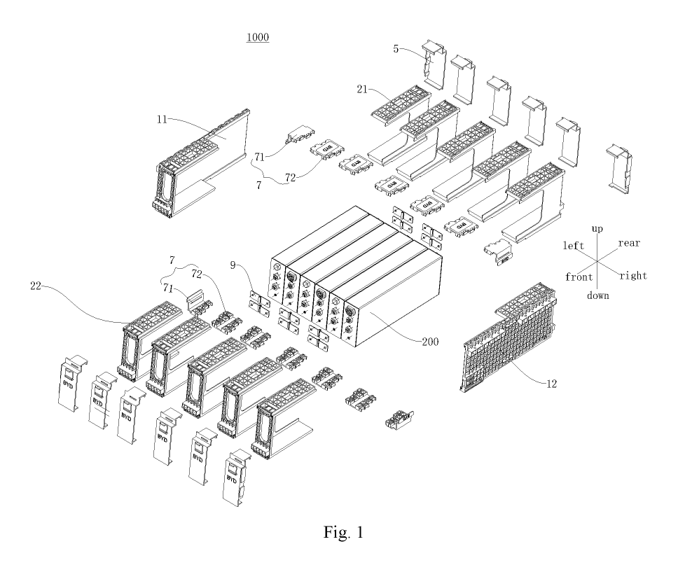

A battery accommodating device 100 according to embodiments of a first aspect of the present disclosure will be described in the following with reference to FIGS. 1-12. In one embodiment, the battery accommodating device 100 is used to accommodate a battery 200, thus obtaining a battery module 1000. In one embodiment, the battery accommodating device 100 according to embodiments of the present disclosure includes an outer insertion-connected assembly 1 and an inner insertion-connected assembly 2.

It should be noted that, in the description of the present disclosure below, terms used to denote the direction, such as “upper and lower”, “front and rear”, “left and right” as well as derivative thereof, should be construed to refer to the direction as then described or shown in the drawings. These relative terms are for convenience of exemplary description and do not require that the present disclosure be constructed or operated in a particular direction or position relationship.

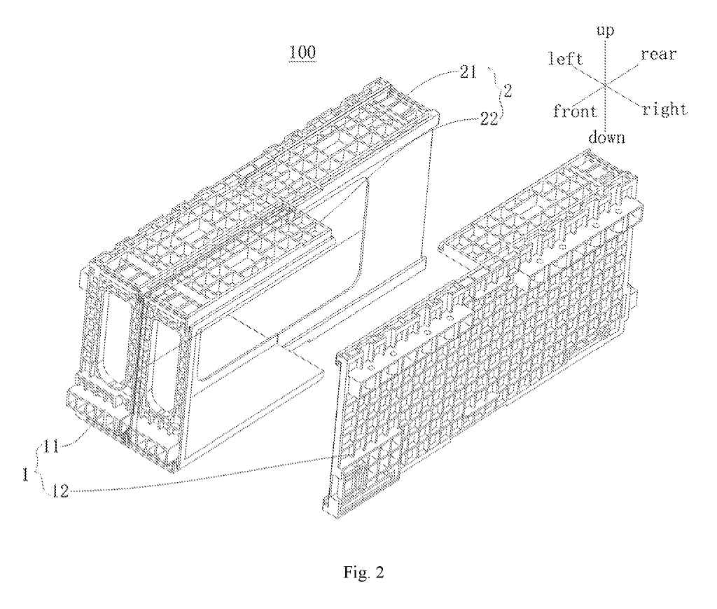

As shown in FIGS. 1 and 2, the outer insertion-connected assembly 1 includes a first outer insertion-connected component 11 and a second outer insertion-connected components 12. The first and second outer insertion-connected components 11 and 12 are opposite to and spaced from each other in a right and left direction. The inner insertion-connected assembly 2 is disposed between the first and second outer insertion-connected components 11 and 12 in the right and left direction. The inner insertion-connected assembly 2 includes a first inner insertion-connected component 21 and a second inner component 22 staggered with each other in a front and rear direction. A chamber for accommodating the batter 200 is defined between the adjacent inner insertion-connected components of the inner insertion-connected assembly 2, and between the inner insertion-connected component and adjacent one of the first and second outer insertion-connected components 11 and 12. In addition, each of the first and second outer insertion-connected components 11 and 12 is fitted with the first and second inner insertion-connected components 21 and 22 via a sliding rail structure, respectively.

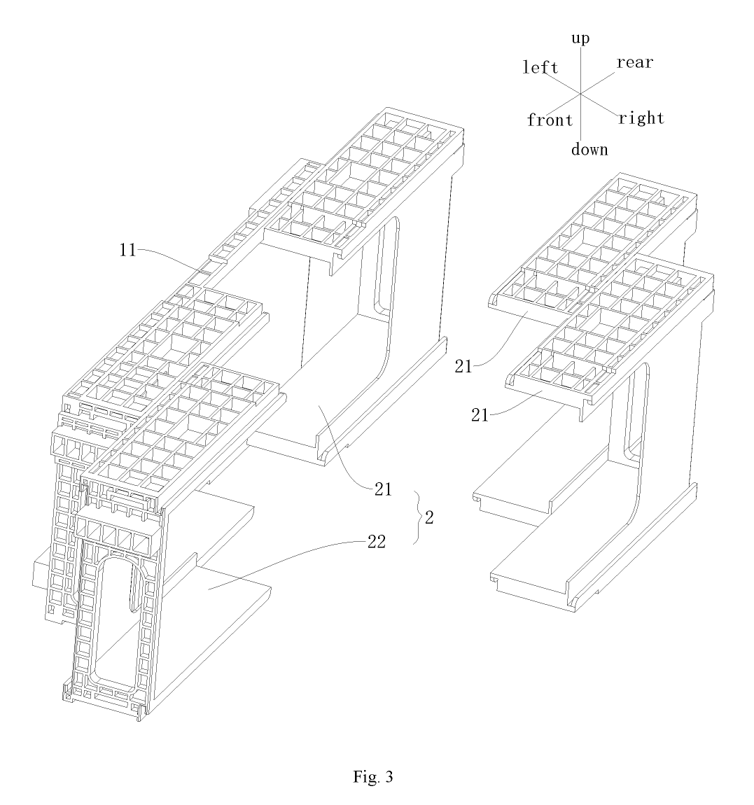

In another embodiment of the present disclosure, as shown in FIG. 3, a plurality of inner insertion-connected assemblies are disposed between the first and second outer insertion-connected components 11 and 12. The chamber is further defined between adjacent inner insertion-connected assemblies, and the battery 200 is received in the chamber. In addition, the adjacent inner insertion-connected components are fitted with each other via the sliding rail structure.

In one embodiment, in the front and rear direction, the first and second inner insertion-connected components 21 and 22 of the inner insertion-connected assembly 2 are not opposite to each other, but staggered to each other, which can be seen in FIG. 2.

The outer insertion-connected component and the inner insertion-connected component are detachably connected with adjacent inner insertion-connected component respectively.

With the battery accommodating device 100 according to embodiments of the present disclosure, by disposing the outer insertion-connected assembly 1 including the first and second outer insertion-connected components, and the inner insertion-connected assembly 2 including the first and second inner insertion-connected components, the chamber for housing the battery is defined by adjacent inner insertion components and by the inner insertion-connected component and the adjacent outer insertion-connected component. The outer insertion-connected component and the inner insertion-connected component are fitted with the adjacent inner insertion-connected component via the sliding rail structure and detachably connected therewith respectively. Thus the number of batteries can be extended easily with the battery accommodating device 100 according to actual requirements.

Besides, since the outer insertion-connected component and the inner insertion-connected component are detachably connected with the adjacent inner insertion-connected component respectively, the assembling and disassembling of the battery accommodating device 100 both are easy to carry out. Thus the assembling process is simplified and assembling efficiency thereof is improved.

Further, the expansibility of the power battery module 1000 is improved, the R&D cost of the power battery module 1000 is decreased, and the time for development of the power battery module 1000 is shortened.

In some embodiments, each of the first and second outer insertion-connected components 11 and 12 has a sliding groove 3 or a sliding block 4. Each of the first and second inner insertion-connected components 21 and 22 has a sliding groove 3 in a left side thereof and a sliding block 4 on a right side thereof. The sliding groove 3 of the inner insertion-connected component is adapted to fit with the sliding block 4 of the outer insertion-connected component or the sliding block 4 of an adjacent inner insertion-connected component. In other words, in the right and left direction, adjacent inner insertion-connected components are connected with each other via the sliding groove 3 and the sliding block 4, or the outer insertion-connected component and the adjacent inner insertion-connected component are connected with each other via the sliding groove 3 and sliding block 4. The sliding groove 3 and the sliding block 4 both are components of the sliding rail structure.

The sliding groove 3 may be a groove structure, the sliding block 4 may be a continuous bar structure, or may be a discontinuous protrusion structure, as long as the sliding block 4 can slide within the sliding groove 3.

Alternatively, there may be no requirement to mount a connection structure between the first and second inner insertion-connected components 21 and 22 of one inner insertion-connected assembly 2 which are staggered to each other. And these inner insertion-connected components may be connected with the adjacent inner insertion-connected components or outer insertion-connected components via an insertion connection, thus the structure of the first and second inner insertion-connected components 21 and 22 of the inner insertion-connected assembly 2 is simplified. Thus the assembling and disassembling thereof are easy to carry out.

The outer insertion-connected component of the battery accommodating device 100 according to the embodiments of the present disclosure will be described below with reference to FIGS. 1 to 4. As shown in FIGS. 1 to 4, the outer insertion-connected component includes an outer side plate 111 and an insertion-connected frame 112.

The outer side plate 111 has a plate shape. The outer side plate 111 of the outer insertion-connected components is disposed at an outermost side of the battery accommodating device 100, as shown in FIG. 1. The outer side plate 111 of the first outer insertion-connected component 11 is disposed at a left end of the battery accommodating device 100, and the other outer side plate 111 of the second outer insertion-connected component 12 is disposed at a right end of the battery accommodating device 100.

The outer side plate 111 includes a first plate segment 1111 and a second plate segment 1112, and the insertion-connected frame 112 is disposed on the first plate segment 1111 of the outer side plate 111. The first inner insertion-connected component 21 of the inner insertion-connected assembly 2 adjacent to the outer insertion-connected component is connected with the second plate segment 1112 of the outer side plate 111 and opposite to the insertion-connected frame 112. Alternatively, the first inner insertion-connected component 21 of the inner insertion-connected assembly 2 adjacent to the outer insertion-connected component is connected with the second plate segment 1112 of the outer side plate 111 via the sliding groove 3 and the sliding block 4. The second inner insertion-connected component 22 of the inner insertion-connected assembly 2 adjacent to the outer insertion-connected component is connected with a side of the insertion-connected frame 112 away from the outer side plate. Alternatively, the second inner insertion-connected component 22 of the inner insertion-connected assembly 2 adjacent to the outer insertion-connected component is connected with the insertion-connected frame 112 via the sliding groove 3 and the sliding block 4.

In some embodiments, as shown in FIG. 2, the chamber may be defined between the first outer insertion-connected component 11 and the first inner insertion-connected component 21 connected with the second plate segment 1112 of the first outer insertion-connected component 11. Two chambers may be defined between two outer insertion-connected components and two inner insertion-connected components, thus two batteries 200 may be received in these two chambers. In one embodiment, the battery accommodating device 100 may accommodate two or more batteries 200 if the plurality of the inner insertion-connected assemblies 2 are provided, which fulfills the requirement of the expansion of the battery module 1000 and facilitates the assembly and disassembly of the battery accommodating device 100.

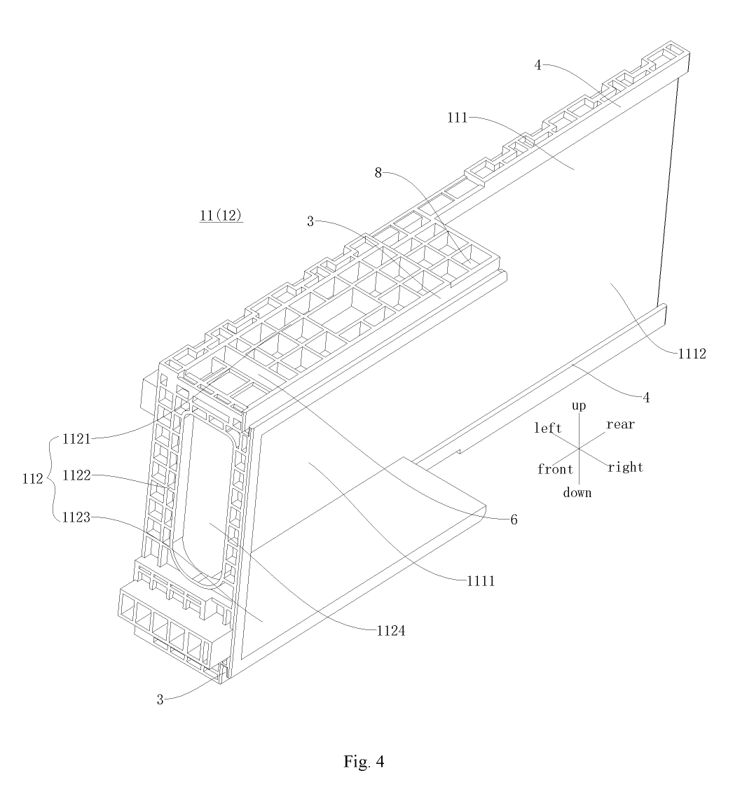

Furthermore, the insertion-connected frame 112 includes an outer top plate 1121, an outer end plate 1122, and an outer bottom plate 1123. The outer top plate 1121 is connected with a top of the outer side plate 111 (i.e., an upper part of the outer side plate 111 in FIGS. 2 and 4) and perpendicular thereto. The outer end plate 1122 is connected with an end of the first plate segment 1111 of the outer side plate 111 away from the second plate segment 1112 and perpendicular thereto. The outer bottom plate 1123 is connected with a bottom of the outer side plate 111 and perpendicular thereto, and opposite to the outer top plate 1121. In other words, as shown in FIG. 4, the outer top plate of 1121 of the insertion-connected frame 112 is vertically connected with the top of the first plate segment 1111 of the outer side plate 111. The outer bottom plate 1123 of the insertion-connected frame 112 is vertically connected with the bottom of the first plate segment 1111 of the outer side plate 111, and opposite to the outer top plate 1121. The outer end plate 1122 is vertically connected with the end of the outer side plate 111 away from the second plate segment 1112. An upper end of the outer end plate 1122 is connected with the outer top plate 1121, and a lower end of the outer end plate 1122 is connected with the outer bottom plate 1123.

In some embodiments, alternatively, each of the outer top plate 1121 and the outer bottom plate 1123 may have a sliding groove 3 or a sliding block at a side thereof away from the outer side plate 111. The sliding groove 3 or the sliding block 4 is adapted to fit with the second inner insertion-connected component 22 of the inner insertion-connected assembly 2 adjacent to the outer insertion-connected component. As shown in FIG. 4, each of the outer top plate 1121 and the outer bottom plate 1123 has the sliding groove at the side thereof away from the outer side plate 111. The sliding groove 3 is adapted to fit with the second inner insertion-connected component 22 of the inner insertion-connected assembly 2 adjacent to the outer insertion-connected component. The sliding groove 3 of the outer top plate 1121 opens in a first direction opposite to a second direction in which the sliding groove 3 of the outer bottom plate 1123 opens. In one embodiment, as shown in FIG. 4, the sliding groove 3 of the outer top plate 1121 opens in an upward direction, while the sliding groove 3 of the outer bottom plate 1123 opens in a downward direction.

Accordingly, the second inner insertion-connected component 22 fitted with the insertion-connected frame 112 of the outer insertion-connected component has a sliding block 4 in a corresponding position thereof. The sliding block 4 of the second inner insertion-connected component 22 is adapted to fit within the sliding groove 3 of the insertion-connected frame 112 (i.e., the sliding grooves 3 of the outer top plate 1121 and the outer bottom plate 1123).

In some embodiments, the outer insertion-connected component and the adjacent inner insertion-connected component may move with respect to each other in the front and rear direction so as to be assembled together. The second inner insertion-connected component 22 may move by sliding the sliding block 4 thereof within and along the sliding groove 3 of the outer insertion-connected component, and stops when the second inner insertion-connected component 22 is completely mounted to the outer insertion-connected component. Preferably, the sliding groove 3 may be configured as a through structure in the front and rear direction, which further facilitates the mounting of the outer insertion-connected component and the adjacent inner insertion-connected component. Thus the inner insertion-connected component can be mounted to the outer insertion-connected component via the insertion connection in a front or rear direction.

In some embodiments, the second plate segment 1112 of the outer side plate 111 has a sliding groove 3 or a sliding block 4 at a top and a bottom thereof respectively. The sliding groove 3 or the sliding block 4 is adapted to fit with the first inner insertion-connected component 21 of the inner insertion-connected assembly 2 adjacent to the outer insertion-connected. As shown in FIG. 4, the second plate segment 1112 of the outer side plate 111 has the sliding block 4 at the top and the bottom thereof respectively. The sliding block 4 is adapted to fit with the first inner insertion-connected component 21 of the inner insertion-connected assembly 2 adjacent to the outer insertion-connected component. The sliding block 4 at the top of the second plate segment 1112 has an extending direction opposite to that of the sliding block 4 at the bottom of the second plate segment 1112. As shown in FIG. 4, the sliding block 4 at the top of the second part 1112 has an downward extending direction, while the sliding block 4 at the bottom of the second part 1112 has an upward extending direction.

Accordingly, the first inner insertion-connected component 21 fitted with the second plate segment 1112 of the outer insertion-connected component has a sliding groove 3 in a corresponding position thereof, so that the first inner insertion-connected component 21 can be fitted with the second plate segment 1112 via the insertion connection.

In some embodiments, the outer end plate 1122 has a first extraction hole 1124 penetrated therethrough. In one embodiment, when the battery 200 is received within the chamber of the battery accommodating device 100, an electrode terminal of the battery 200 may extend out of the chamber of the battery accommodating device 100 through the first extraction hole 1124 so as to achieve an electrical connection of the battery 200. Alternatively, the battery module 1000 further includes a plurality of connecting members 9 which are used to connect the batteries 200. The batteries 200 may be connected with each other in series or in parallel by the connecting members 9.

In some embodiments of the present disclosure, the battery accommodating device 100 further includes a plurality of protective covers 5. The protective cover 5 is disposed at an end of the outer insertion-connected component adjacent to the outer end plate thereof. As shown in FIG. 1, the protective cover 5 is disposed on the outer insertion-connected component and closes the outer end plate 1122. As mentioned above, the first extraction hole 1124 is formed in the outer end plate 1122, thus the protective cover 5 may protect the electrode terminal of the battery 200 which extends out through the first extraction hole 1124.

In some embodiments, the protective cover includes a cover body 51. The cover body 51 may have a plate shape. The outer top plate 1121 of the outer insertion-connected component defines a slot 6. The protective cover 5 has a snap component 52 adapted to fit within the slot 6 at an upper end thereof (i.e., an upper end of the cover plate 51), so that the protective cover 5 may be detachably mounted on the outer insertion-connected component, thus facilitating the mounting and the dismounting thereof.

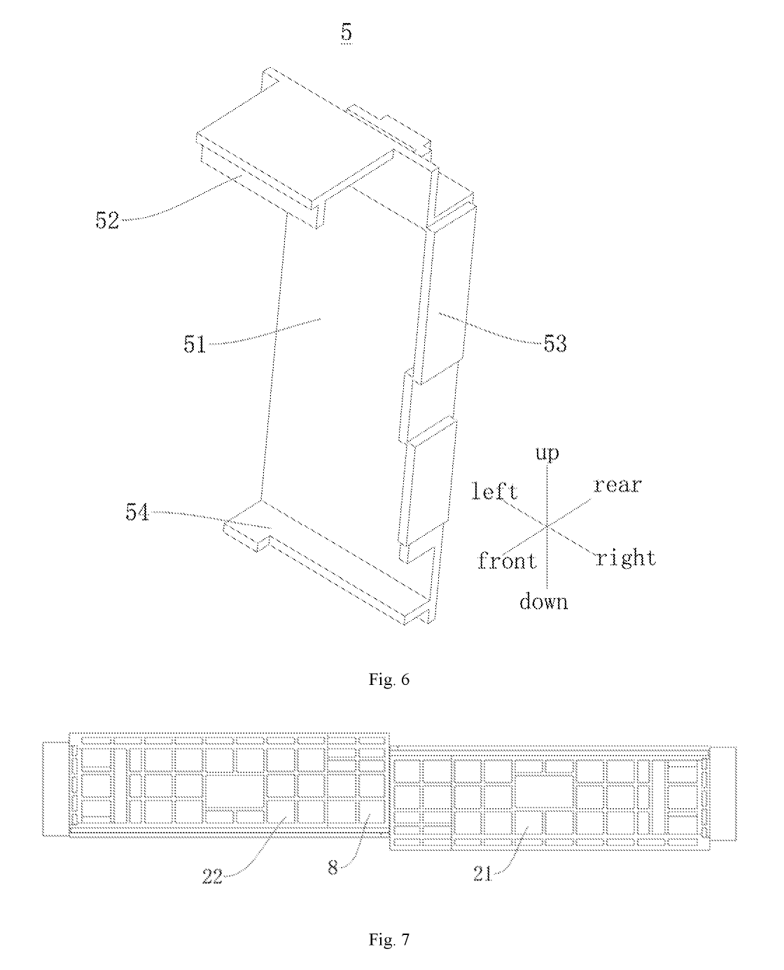

In some embodiments, the protective cover 5 disposed at the end of the outer insertion-connected component has a first package edge 53 adapted to fit with an outermost side of the outer insertion-connected component, as shown in FIG. 6. Thus the first package edge 53 can protect the outermost side of the battery accommodating device 100 through the first package edge 53. Furthermore, the protective cover 5 has a flange 54 adapted to fit with the outer end plate 1122 or the inner end plate 212 at a lower end thereof, thus the mounting of the protective cover 5 can be more stable.

In one embodiment, structures of the first and second outer insertion-connected components 11 and 12 are the same as each other, but assembling directions thereof are opposite when the first and second outer insertion-connected components 11 and 12 are assembled. As shown in FIGS. 1 and 2, the first outer insertion-connected component 11 is disposed at the left side, and the insertion-connected frame 112 of the first outer insertion-connected component 11 is disposed at a front side of the second plate segment 1112 of the outer side plate 111. The second outer insertion-connected component 12 is disposed at the right side, and the insertion-connected frame 112 of the second outer insertion-connected component 12 is disposed at a rear side of the second plate segment 1112 of the outer side plate 111. Thus the manufacturing process of the battery accommodating device 100 is simplified and the manufacturing difficulty is reduced.

The inner insertion-connected component of the battery accommodating device according to the embodiments of the present disclosure will be described below with reference to FIGS. 1 to 3 and FIG. 5. As shown in FIGS. 1 to 3 and FIG. 5, the inner insertion-connected component includes: an inner top plate 211, an inner end plate 212, an inner bottom plate 213, and an inner baffle plate 214.

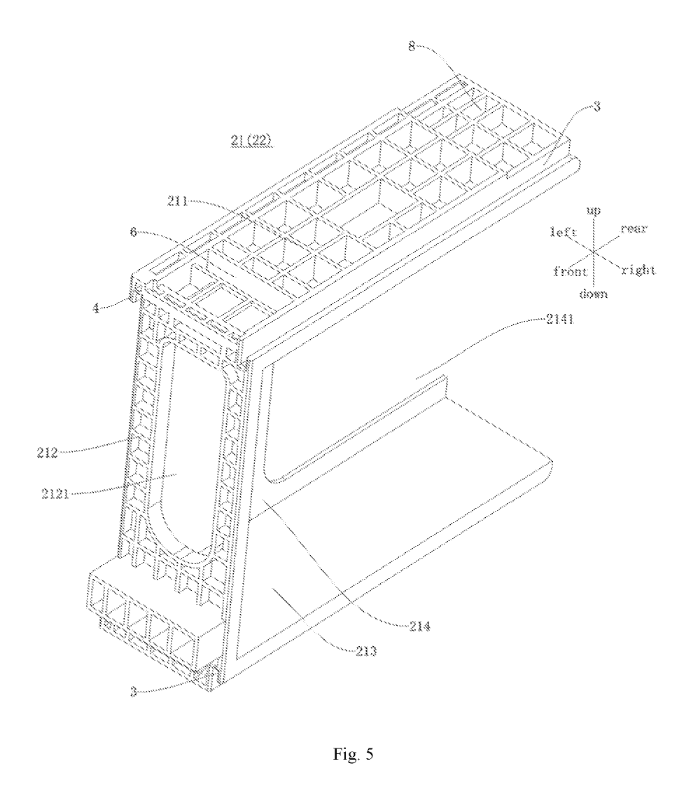

As shown in FIG. 5, the inner top plate 211 has a sliding groove 3 at a left side thereof and a sliding block 4 at a right side thereof. The sliding groove 3 and the sliding block 4 are adapted to fit with the outer insertion-connected component or the inner insertion-connected component adjacent thereto respectively. The inner bottom plate 213 is disposed below the inner top plate 211, and corresponding to the inner top plate 211. The inner bottom plate 213 also has a sliding groove 3 at a left side thereof and a sliding block 4 at a right side thereof. The sliding groove 3 and the sliding block 4 are adapted to fit with the outer insertion-connected component or the inner insertion-connected component adjacent thereto. The inner end plate 212 is disposed at a front end or a rear end of the inner top plate 211 and perpendicular thereto. In one embodiment, as shown in FIG. 5, the inner end plate 212 is disposed at the front end of the inner top plate 211 and perpendicular thereto. The inner bottom plate 213 is connected with a lower end of the end plate 212 and perpendicular thereto.

The inner baffle plate 214 is disposed on a left side or a right side of the inner top plate 211 and perpendicular thereto, and connected with both the inner end plate 212 and the inner bottom plate 213. In one embodiment, as shown in FIG. 5, the inner baffle plate 214 is disposed at the left side of the inner top plate 211. The inner baffle plate 214 has a upper end connected with the left end of the inner top plate 211 and a lower end connected with the left end of the inner bottom plate 213. The inner baffle plate 214 further has a front end connected with the left end of the inner end plate 212.

As shown in FIG. 5, an extending direction of the sliding block 4 of the inner top plate 211 is opposite to that of the sliding block 4 of the inner bottom plate 213. The sliding groove 3 of the inner top plate 211 opens in a first direction opposite to a second direction in which the sliding groove 3 of the inner bottom plate 213 opens.

In some embodiments, the inner baffle plate 214 has a notch 2141 therein, and the notch 2141 opens in a direction away from the inner end plate 212. In this way, the notches 2141 of the first and second inner insertion-connected component 21 and 22, which belong to the same inner insertion-connected assembly 2, can form a complete through hole when the notches 2141 are placed opposite to each other, as shown in FIG. 2. Thus, the battery 200 received in the chamber of the battery accommodating device 100 can be cooled by the ventilation and heat dissipation through the through hole. Preferably, an insulating plate may be disposed in a position in which the through hole is formed by the notches 2141 of the first and second inner insertion-connected components 21 and 22 of the same inner insertion-connected assembly 2. Thus the efficiency of the insulation between adjacent batteries 200 can be enhanced, thus improving the safety thereof.

In one embodiment, structures of all the inner insertion-connected components are the same as each other. In a preferred embodiment, each inner insertion-connected component has the sliding groove 3 at the left side and the sliding block 4 at the right side thereof respectively. Thus the adjacent inner insertion-connected components can be reasonably connected and fitted with each other or the outer insertion-connected component can be reasonably connected and fitted with the adjacent inner insertion-connected components, when the battery accommodating device 100 is assembled.

In some embodiments, the first and second inner insertion-connected components 21 and 22 of the same inner insertion-connected assembly 2 are mounted in opposite directions. As shown in FIG. 2, the first and second inner insertion-connected components 21 and 22 are staggered with each other in the front and rear direction. The inner end plate 212 of the second inner insertion-connected component 22 disposed at the front side faces forward, and the inner end plate 212 of the first inner insertion-connected component 21 disposed at the rear side faces backward. Adjacent inner insertion assemblies 2 may be connected with each other through the sliding groove 3 and the sliding block 4, thus simplifying the manufacturing process of the battery accommodating device 100 and reducing the manufacturing difficulty.

Alternatively, the inner end plate 212 has a second extraction hole 2121 penetrated therethrough. And the electrode terminal of the battery 200 may extend out of the chamber of the battery accommodating device 100 through the second extraction hole 2121 formed in the second extraction hole 2121, so as to achieve the connection in series or in parallel between the batteries 200.

Similarly, the protective cover 5 also may be disposed at an end of the inner insertion-connected component adjacent to the inner end plate 212 thereof. The protective cover 5 may also protect the electrode terminal of the battery 200, which extends out through the second extraction hole 2121.

In some embodiments, the battery accommodating device 100 further includes a mounting assembly 7. The mounting assembly 7 may be used to connect the outer insertion-connected component with the adjacent inner insertion-connected component, or to connect adjacent inner insertion-connected components with each other. Disposing the mounting assembly 72 could improve both the connection stability of the outer insertion-connected component and the adjacent inner insertion-connected component, and the connection stability of the adjacent inner insertion-connected components.

In some embodiments, as shown in FIG. 1, the mounting assembly 7 includes a first mounting component 71 and a second mounting component button 72. The first mounting component 71 is used to connect the outer insertion-connected component with the first inner insertion-connected component 21 of the inner insertion-connected assembly 2 adjacent to the outer insertion-connected component. The second mounting component 72 is used to connect four adjacent inner insertion-connected components together or adjacent three inner insertion-connected components and one outer insertion-connected component together. In one embodiment, the first mounting component 71 is used to connect the outer insertion-connected component disposed at the left or right end of the battery accommodating device 100 with the first inner insertion-connected component of the inner insertion-connected assembly 2 adjacent to this outer insertion-connected component. The second mounting component 72 is used to connect four inner insertion-connected components disposed inside of the battery accommodating device 100 together, or to connect the outer insertion-connected component disposed at the left or right end of the battery accommodating device 100 with three inner insertion-connected components. The three inner insertion-connected components as well as the outer insertion-connected component are adjacent with one another.

Alternatively, the first mounting component 71 and the second mounting component 72 may be disposed on bottom surfaces and/or top surfaces of the inner insertion-connected component and the outer insertion-connected component. Preferably, the second mounting component 72 may be disposed on the bottom surfaces and the top surfaces of the inner insertion-connected component and the outer insertion-connected component respectively, thus making the structure of the battery accommodating device 100 more stable.

For example, in the following description of the present disclosure, the second mounting component 72 is disposed on the bottom surfaces and the top surfaces of the inner insertion-connected component and the outer insertion-connected component respectively. But those skilled in the art should understand that, the second mounting component 72 may only be disposed on the bottom surfaces or the top surfaces of the inner insertion-connected component and the outer insertion-connected component, which also falls into the protection scope of the present disclosure.

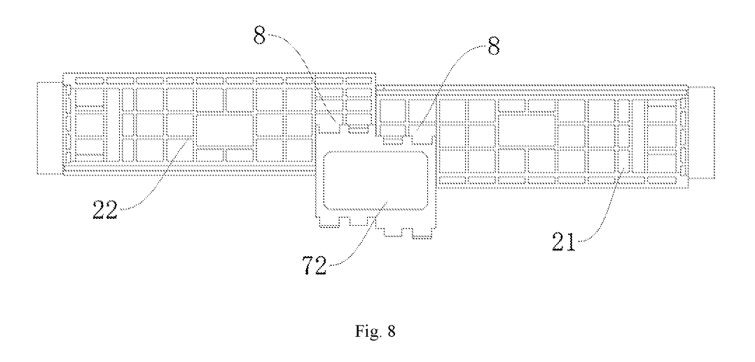

FIG. 7 is a top view of two inner insertion-connected components of two adjacent inner insertion assemblies 2 of a battery accommodating device 100 according to an embodiment of the present disclosure. FIG. 8 is a schematic view of the two inner insertion-connected components shown in FIG. 7 connected with each other via the second mounting component 72.

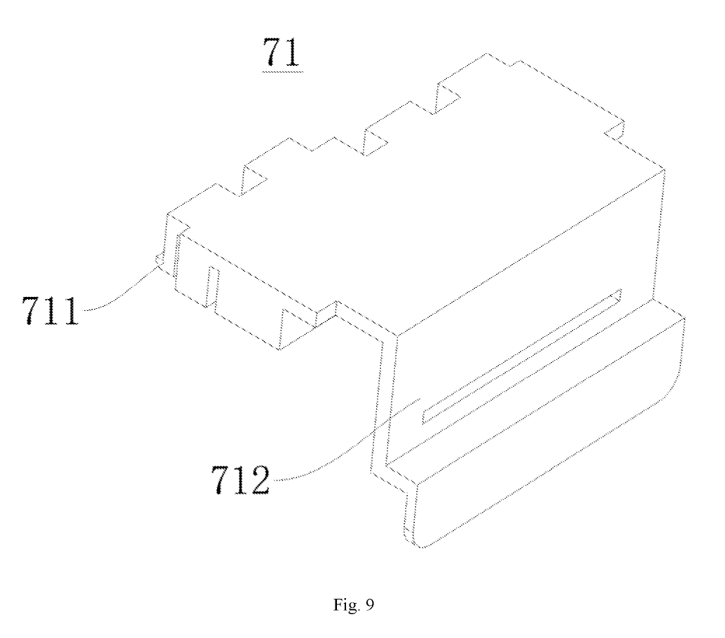

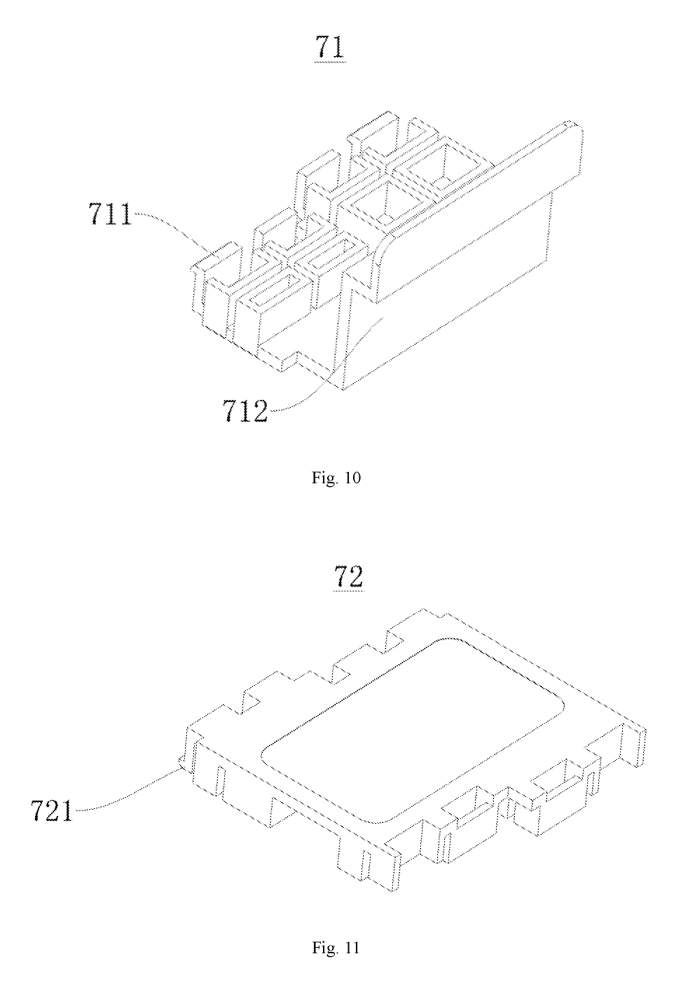

In some embodiments, as shown in FIGS. 9 and 10, the first mounting component 71 has a substantially plate shape. The first mounting component 71 includes a first snap part 711. Each of the outer top plate 1121 of the outer insertion-connected component, the outer bottom plate 1123 of the outer insertion-connected component, the inner top plate 212 and the inner bottom plate 213 of the first inner insertion-connected component 21 of the inner insertion-connected assembly adjacent to the outer insertion-connected component defines a first snap opening 8 adapted to fit with the first snap part 711. Thus, it is more convenient for the mounting of the first mounting component 71.

Further, the first mounting component 71 has a second package edge 712 adapted to fit with the outer side plate 111. Thus, the outermost side of the battery accommodating device 100 is protected by the second package edge 712.

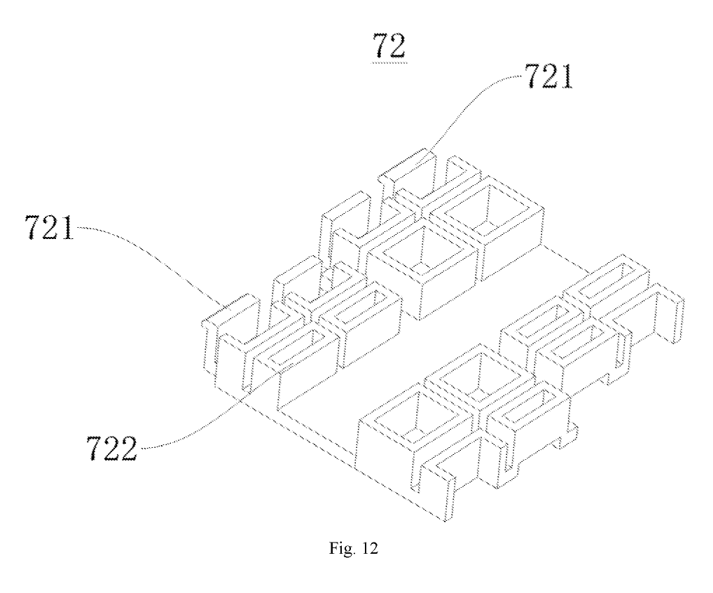

As shown in FIGS. 11 and 12, the second mounting component 72 has a substantial plate shape. The second mounting component 72 includes a second snap part 721. Each of the inner top plate 211, the inner bottom plate 213, the outer top plate 1121 and the outer bottom plate 1123 has a snap opening 8 adapted to fit with the second snap part 721. Thus, it is more convenient for the mounting of the second mounting component 72.

In some embodiments, the second mounting component 72 has a plate shape, as shown in FIG. 8. Four adjacent inner insertion-connected components 21 or four adjacent inner insertion-connected components and outer insertion-connected components may be connected together by the second mounting component 72, thus simplifying the structure.

In a preferred embodiment, the second mounting component 72 has an insertion part 722 on a surface thereof adjacent to the inner insertion-connected components or the outer insertion-connected components. A structure of the insertion part 722 matches with that of the snap opening 8. Thus, the insertion part 722 may be inserted into the snap opening 8, which makes the connection between the second mounting component 72 and the inner insertion-connected components or the outer insertion-connected components more stable. Advantageously, there may be a plurality of the insertion parts 722 and the snap openings 8, such that the connection stability thereof can be further improved.

A battery module 1000 according to embodiments of a second aspect of the present disclosure is provided. The battery module 1000 includes a battery accommodating device 100 according to the above-mentioned embodiments of the first aspect of the present disclosure, and at least one battery 200 accommodated in the chamber of the battery accommodating device 100. As mentioned above, since both the assembling and disassembling of the battery accommodating device 100 are easy to carry out, the assembling process is simplified and the assembling efficiency is improved, the expansibility of the battery module 1000 is improved, the R&D cost of the battery module 1000 is reduced, and the time for development of the battery module 1000 is shortened.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that changes, alternatives, and modifications all fall into the scope of the claims and their equivalents may be made in the embodiments without departing from spirit and principles of the disclosure.

What is claimed is:

1. A battery accommodating device, comprising:
an outer insertion-connected assembly comprising first and second outer insertion-connected components opposite to and spaced from each other in a right and left direction;
an inner insertion-connected assembly disposed between the first and second outer insertion-connected components in the right and left direction, and comprising first and second inner insertion-connected components staggered with each other in a front and rear direction; and
a chamber configured to accommodate a battery, the chamber being defined between the first and second inner insertion-connected components of the inner insertion-connected assembly and adjacent one of the first and second outer insertion-connected components,
wherein each of the first and second outer insertion-connected components is fitted with adjacent first and second inner insertion-connected components via a sliding rail structure.

2. The battery accommodating device of claim 1, wherein a plurality of inner insertion-connected assemblies are disposed between the first and second outer insertion-connected components,
wherein the chamber is further defined between adjacent inner insertion-connected assemblies, and
wherein adjacent inner insertion-connected components are fitted with each other via the sliding rail structure.

3. The battery accommodating device of claim 1, wherein each of the first and second outer insertion-connected components has a sliding groove or a sliding block,
wherein each of the first and second inner insertion-connected components has a sliding groove on one side thereof and a sliding block on another side thereof, and
wherein the sliding groove of the inner insertion-connected component is adapted to fit with the sliding block of the outer insertion-connected component or the sliding block of an adjacent inner insertion-connected component.

4. The battery accommodating device of claim 3, wherein the outer insertion-connected component comprises:
an outer side plate having a first plate segment and a second plate segment; and
an insertion-connected frame disposed on the first plate segment of the outer side plate,
wherein the first inner insertion-connected component of the inner insertion-connected assembly adjacent to the outer insertion-connected component is connected with the second plate segment of the outer side plate and opposite to the insertion-connected frame;
wherein the second inner insertion-connected component of the inner insertion-connected assembly adjacent to the outer insertion-connected component is connected with a side of the insertion-connected frame away from the outer side plate.

5. The battery accommodating device of claim 4, wherein the insertion-connected frame comprises:
an outer top plate connected with a top of the outer side plate and perpendicular thereto,
an outer end plate connected with an end of the first plate segment of the outer side plate away from the second plate segment and perpendicular thereto; and
an outer bottom plate connected with a bottom of the outer side plate and perpendicular thereto, and opposite to the outer top plate.

6. The battery accommodating device of claim 5, wherein each of the outer top plate and the outer bottom plate has a sliding groove or a sliding block at a side thereof away from the outer side plate, and wherein the sliding groove or the sliding block is adapted to fit with the second inner insertion-connected component of the inner insertion-connected assembly adjacent to the outer insertion-connected component.

7. The battery accommodating device of claim 6, wherein each of the outer top plate and the outer bottom plate has the sliding groove at the side thereof away from the outer side plate, wherein the sliding groove is adapted to fit with the second inner insertion-connected component of the inner insertion-connected assembly adjacent to the outer insertion-connected component, and wherein the sliding groove of the outer top plate opens in a first direction opposite to a second direction in which the sliding groove of the outer bottom plate opens.

8. The battery accommodating device of claim 7, wherein the second plate segment of the outer side plate has a sliding groove or a sliding block at a top and a bottom thereof respectively, and wherein the sliding groove or the sliding block is adapted to fit with the first inner insertion-connected component of the inner insertion-connected assembly adjacent to the outer insertion-connected component.

9. The battery accommodating device of claim 8, wherein the second plate segment of the outer side plate has the sliding block at the top and the bottom thereof respectively, wherein the sliding block is adapted to fit with the first inner insertion-connected component of the inner insertion-connected assembly adjacent to the outer insertion-connected component, and wherein the sliding block at the top of the second plate segment has an extending direction opposite to that of the sliding block at the bottom of the second plate segment.

10. The battery accommodating device of claim 5, wherein the outer end plate defines a first extraction hole penetrated therethrough.

11. The battery accommodating device of claim 4, wherein the inner insertion-connected component comprises:
an inner top plate having a sliding groove on one side thereof and a sliding block on another side thereof, the sliding groove and the sliding block being adapted to fit with the outer insertion-connected component or the inner insertion-connected component adjacent thereto respectively;
an inner end plate disposed at a front end or a rear end of the inner top plate and perpendicular thereto;
an inner bottom plate disposed at a lower end of the inner end plate and perpendicular thereto, having a sliding groove on one side thereof and a sliding block on another side thereof, the sliding groove and the sliding block being adapted to fit with the outer insertion-connected component or the inner insertion-connected component adjacent thereto; and
an inner baffle plate disposed at the left side or the right side of the inner top plate and perpendicular thereto, and connected with the inner end plate and the inner bottom plate.

12. The battery accommodating device of claim 11, wherein an extending direction of the sliding block of the inner top plate is opposite to that of the sliding block of the inner bottom plate, and wherein the sliding groove of the inner top plate opens in a first direction opposite to a second direction in which the sliding groove of the inner bottom plate opens.

13. The battery accommodating device of claim 11, wherein the inner end plate defines a second extraction hole penetrated therethrough.

14. The battery accommodating device of claim 11, wherein the inner baffle plate defines a notch that opens in a direction away from the inner end plate.

15. The battery accommodating device of claim 11, further comprising a plurality of protective covers, wherein
the protective cover is disposed at an end of the inner insertion-connected component adjacent to the inner end plate thereof and/or an end of the outer insertion-connected component adjacent to the outer end plate thereof.

16. The battery accommodating device of claim 15, wherein the inner top plate of the inner insertion-connected component or the outer top plate of the outer insertion-connected component defines a slot, and
wherein the protective cover has a snap component adapted to fit within the slot at an upper end thereof, and a flange adapted to fit with the outer end plate or the inner end plate at a lower end thereof.

17. The battery accommodating device of claim 16, wherein the protective cover disposed at the end of the outer insertion-connected component has a first package edge adapted to fit with an outermost side of the outer insertion-connected component.

18. The battery accommodating device of claim 11, further comprising a mounting assembly, wherein the mounting assembly is configured to connect the outer insertion-connected component with the inner insertion-connected component adjacent thereto, or connect adjacent inner insertion-connected components with each other.

19. The battery accommodating device of claim 18, wherein the mounting assembly comprises:
a first mounting component configured to connect the outer insertion-connected component with the first inner insertion-connected component of the inner insertion-connected assembly adjacent to the outer insertion-connected component; and
a second mounting component configured to connect four adjacent inner insertion-connected components together or adjacent three inner insertion-connected components and one outer insertion-connected component together.

20. A battery module, comprising:
a battery accommodating device according to claim 1, and
at least one battery accommodated in a chamber of the battery accommodating device.
